(19) United States
(12) Patent Application Publication
(10) Pub. No.: US 2024/0281494 A1
(43) Pub. Date: Aug. 22, 2024

(54) Apparatus and Method for Setting Criteria on Data Classification

(71) Applicant: Hyperconnect LLC, Seoul (KR)

(72) Inventors: Yong Su Baek, Seoul (KR); Dong Hyun Son, Seoul (KR); Beom Jun Shin, Seoul (KR); Byoung Gyu Lew, Seoul (KR); Bu Ru Chang, Seoul (KR); Kwang Hee Choi, Seoul (KR); Seung Woo Choi, Seoul (KR); Sung Joo Ha, Seoul (KR)

(73) Assignee: Hyperconnect LLC, Gangnam-gu (KR)

(21) Appl. No.: 18/542,409

(22) Filed: Dec. 15, 2023

(30) Foreign Application Priority Data
Feb. 20, 2023 (KR) 10-2023-0022176

(51) Int. Cl. G06F 17/11

(52) U.S. Cl. CPC G06F 17/11

(57) ABSTRACT

Provided is a method of setting criteria for classification of data in an electronic apparatus, the method including identifying a subtask related to data classification, obtaining a plurality of data, based on a model associated with the subtask, obtaining a score associated with the subtask for each of the plurality of data, identifying category information associated with the subtask for each of the plurality of data, and based on the category information and the score, determining a threshold value corresponding to the subtask.

### CROSS-REFERENCE TO RELATED APPLICATIONS

This application claims the benefit of Korean Patent Application No. 10-2023-0022176, filed on Feb. 20, 2023, in the Korean Intellectual Property Office, the disclosure of which is incorporated herein by reference.

### FIELD OF THE INVENTION

Example embodiments relate to an apparatus that establishes criteria for classifying data and a method thereof. More specifically, the example embodiments relate to an electronic apparatus that identifies a subtask related to data classification, based on a model associated with the subtask, obtains a score associated with the subtask for each of a plurality of data, identifies category information associated with the subtask for each of the plurality of data, and based on the category information and the score, determines a threshold value corresponding to the subtask, and relate to a method thereof.

### BACKGROUND

Various attempts to solve the problem of classifying data using machine learning technology have been steadily made. Although neural network-based data classification methods are continuously evolving, the methods still require a large amount of data and calculations to train neural networks, and thus the methods consume a lot of time, manpower, cost, and amount of calculation.

Specifically, in an environment where data classification rules change frequently, a new machine learning model is trained whenever the rules change. This involves preparing labeled data according to the new rules and training a model while consuming a considerable amount of calculation. Consequently, there is a problem that the consumption of the aforementioned time, manpower, cost, and amount of calculation is further increased over the initial training. For example, criteria related to the classification of harmful content may be easily changed according to shifts in policies. To give an example, if the classification criterion is changed from determining that a bleeding image is harmful to determining that the bleeding image is harmless, the data is to be relabeled according to the changed criterion and the model is to be retrained based on the relabeled data.

With regard thereto, prior arts KR102445468B1 and KR102315574B1 may be referred to, the contents of which are incorporated by reference herein.

### SUMMARY OF THE INVENTION

Apparatuses and methods in accordance with various embodiments of the invention identify a subtask related to data classification, obtain a plurality of data, based on a model associated with the subtask, obtain a score associated with the subtask for each of the plurality of data, identify category information associated with the subtask for each of the plurality of data and, based on the category information and the score, determine a threshold value corresponding to the subtask.

One embodiment of the invention provides a method of setting criteria for classification of data in an electronic apparatus, the method including identifying a subtask related to data classification, obtaining a plurality of data, based on a model associated with the subtask, obtaining a score associated with the subtask for each of the plurality of data, identifying category information associated with the subtask for each of the plurality of data, and based on the category information and the score, determining a threshold value corresponding to the subtask.

In a further embodiment, determining the threshold value may include setting a threshold function that takes a value obtained by subtracting the threshold value from the score as an input and optimizing the threshold function based on the category information and the score, wherein the threshold function is trained to output a value associated with the category information.

In a further still embodiment, the threshold function may include a Heaviside step function (HSF).

In another embodiment, optimizing the threshold function may include obtaining a differentiable similar threshold function based on the threshold function and updating one or more parameters including the threshold value by performing backpropagation on the similar threshold function.

In still another embodiment, the similar threshold function may include a sigmoid function.

In a further embodiment, the one or more parameters may include a parameter related to a form of the similar threshold function.

In yet another embodiment, determining the threshold value may include obtaining a loss function that reflects at least one of precision and recall related to the data classification and determining the threshold value in a direction in which a value of the loss function is minimized.

In another embodiment, obtaining the score may include inputting the plurality of data into the model and obtaining an output of the model for each of the plurality of data.

In still another embodiment, obtaining the score may further include obtaining the score by normalizing the output of the model to a value between 0 and 1.

In another embodiment, the method may further include obtaining target data associated with the subtask and classifying the target data based on the threshold value.

In still another embodiment, classifying the target data may include inputting the target data to the model, obtaining an output of the model, and obtaining the category information corresponding to the target data by comparing the output of the model with the threshold value.

In yet another embodiment, classifying the target data may further include obtaining rule information related to classification of the target data and determining a class of the target data based on the rule information and the category information corresponding to the target data.

In still yet another embodiment, there is provided a method of providing information in an electronic apparatus using a trained model, the method including: identifying rule information associated with data classification of the model and at least one subtask related to the rule information, obtaining information on one or more set threshold values corresponding to each of one or more subtasks, obtaining subject data, and based on the information on the one or more threshold values, outputting a result of whether the rule information for the subject data is complied with.

In an additional embodiment, outputting the result of whether the rule information for the subject data is complied with may include outputting score information corresponding to the subject data based on the one or more subtasks and comparing the score information and the information on the one or more threshold values.

In still further embodiments, the model may include a first sub-model and a second sub-model, the electronic apparatus may output score information corresponding to the subject data using the second sub-model, the score information may be transferred from the second sub-model to the first sub-model, and the electronic apparatus may compare the score information and the information on the one or more threshold values by using the first sub-model.

In a further additional embodiment, outputting the result of whether the rule information for the subject data is complied with may further include obtaining category information of the subject data associated with the at least one subtask based on a result of the comparison and determining whether the rule information is complied with based on the category information.

In still another additional embodiment, there is provided an electronic apparatus of setting criteria for classifying data, including a memory configured to store instructions and a processor, wherein the processor, connected to the memory, is configured to identify a subtask related to data classification, obtain a plurality of data, based on a model associated with the subtask, obtain a score associated with the subtask for each of the plurality of data, identify category information associated with the subtask for each of the plurality of data, and based on the category information and the score, determine a threshold value corresponding to the subtask.

In yet another embodiment again, it is possible to minimize the waste of time, manpower, cost and amount of calculation and to respond flexibly to changes in rules, since by determining a threshold value corresponding a subtask and classifying data based on it, even if the rules related to data classification change, there is no need to prepare the data labeled according to the new rules or train a model anew.

Additional embodiments and features are set forth in part in the description that follows, and in part will be apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

FIG. 1 is a diagram for explaining a method of classifying data based on a subtask in accordance with an embodiment of the invention;

FIG. 2 is a diagram for explaining a method of determining how well data classification is performed, together with examples related to data classification in accordance with an embodiment of the invention;

FIG. 3 is a diagram for explaining a method of classifying data based on one or more subtasks in accordance with an embodiment of the invention;

FIG. 4 is an operation flowchart illustrating a method of setting a criterion for classifying data in accordance with an embodiment of the invention;

FIG. 5 is a view illustrating a specific example embodiment of determining a threshold value corresponding to a subtask by optimizing a threshold function in accordance with an embodiment of the invention; and

FIG. 6 is a diagram of the configuration of an electronic apparatus for setting criteria for classifying data in accordance with an embodiment of the invention.

### DETAILED DESCRIPTION

Terms used in the example embodiments are selected from currently widely used general terms when possible while considering the functions in the present disclosure. However, the terms may vary depending on the intention or precedent of a person skilled in the art, the emergence of new technology, and the like. Further, in certain cases, there are also terms arbitrarily selected by the applicant, and in such cases, the meaning will be described in detail in the corresponding descriptions. Therefore, the terms used in the present disclosure should be defined based on the meaning of the terms and the contents of the present disclosure, rather than the simple names of the terms.

Throughout the specification, when a part is described as “comprising” or “including” a component, it does not exclude another component but may further include another component unless otherwise stated. Furthermore, terms such as “ . . . unit,” “group,” and “ . . . module” described in the specification mean a unit that processes at least one function or operation, which may be implemented as hardware, software, or a combination thereof.

Expression “at least one of a, b and c” described throughout the specification may include “a alone,” “b alone,” “c alone,” “a and b,” “a and c,” “b and c” or “all of a, b and c.”

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

Hereinafter, example embodiments of the present disclosure will be described in detail with reference to the accompanying drawings.

In describing the example embodiments, descriptions of technical contents that are well known in the technical field to which the present disclosure pertains and that are not directly related to the present disclosure will be omitted. This is to more clearly convey the gist of the present disclosure without obscuring the gist of the present disclosure by omitting unnecessary description.

For the same reason, some elements may be exaggerated, omitted or schematically illustrated in the accompanying drawings. In addition, the size of each element does not fully reflect the actual size. In each figure, the same or corresponding elements are assigned the same reference numerals.

Advantages and features of the present disclosure, and a method of achieving the advantages and the features will become apparent with reference to the example embodiments described below in detail together with the accompanying drawings. However, the present disclosure is not limited to the example embodiments disclosed below, and may be implemented in various different forms. The example embodiments are provided only so as to render the present disclosure complete, and completely inform the scope of the present disclosure to those of ordinary skill in the art to which the present disclosure pertains. The present disclosure is only defined by the scope of the claims. Like reference numerals refer to like elements throughout.

In this case, it will be understood that each block of a flowchart diagram and a combination of the flowchart diagrams may be performed by computer program instructions. The computer program instructions may be embodied in a processor of a general-purpose computer or a special purpose computer, or may be embodied in a processor of other programmable data processing equipment. Thus, the instructions, executed via a processor of a computer or other programmable data processing equipment, may generate a part for performing functions described in the flowchart blocks. To implement a function in a particular manner, the computer program instructions may also be stored in a computer-usable or computer-readable memory that may direct a computer or other programmable data processing equipment. Thus, the instructions stored in the computer usable or computer readable memory may be produced as an article of manufacture containing an instruction part for performing the functions described in the flowchart blocks. The computer program instructions may be embodied in a computer or other programmable data processing equipment. Thus, a series of operations may be performed in a computer or other programmable data processing equipment to create a computer-executed process, and the computer or other programmable data processing equipment may provide steps for performing the functions described in the flowchart blocks.

Additionally, each block may represent a module, a segment, or a portion of code that includes one or more executable instructions for executing a specified logical function(s). It should also be noted that in some alternative implementations the functions recited in the blocks may occur out of order. For example, two blocks shown one after another may be performed substantially at the same time, or the blocks may sometimes be performed in the reverse order according to a corresponding function.

As an example to which the method of the present disclosure may be applied, there is content moderation related to online service provision. More specifically, various online service providers, such as social media platforms, are trying to protect users from harmful content through content moderation. However, there is a limit to the accuracy of individual human classification of data as the amount of content created every day is too vast to process by mobilizing manpower. Furthermore, there are also mental health problems for personnel who repeatedly deal with harmful content. Due to these problems, in recent years, there are many cases in which a large amount of user-created content is processed daily using a machine learning model.

Since moderation policies may differ depending on countries and product types, it is common to train and distribute models for each policy. However, this approach has the disadvantage of being very inefficient, especially when a policy changes, requiring relabeling datasets and retraining models for shifted data distributions.

In order to alleviate cost inefficiencies, instead of directly providing the final reconciliation decision (in other words, directly obtaining the class of data based on the model), processes in accordance with a variety of embodiments of the invention (e.g., by a provider of an online service, such as a social media platform), may obtain prediction scores for one or more subtasks that can be instantiated such as predicting the presence of a minor, a rude gesture and a weapon, and the final class may be determined based thereon.

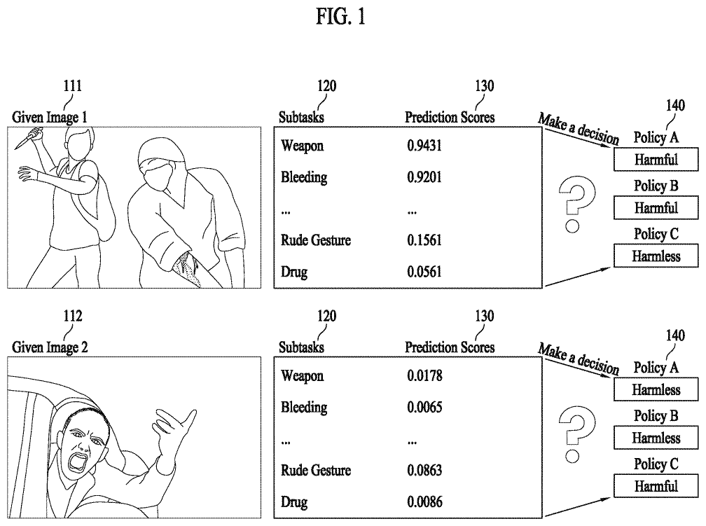

A method of classifying data based on a subtask in accordance with an embodiment of the invention is illustrated in FIG. 1. In numerous embodiments, instead of directly obtaining classes of the data based on the model, scores of data associated with subtasks may be obtained based on the model associated with the subtasks and the data may be classified by comparing the obtained scores with threshold values for each of the subtasks. In certain embodiments, the category information for each of the subtasks of the data may be identified.

For example, with regard to a first image 111 and a second image 112, prediction scores 130 may be obtained for subtasks 120 such as, but not limited to, weapon, bleeding, rude gesture, and/or drug. Based thereon, whether the content is harmful may be determined for each of several policies 140. To illustrate, if policy A is a policy that determines if an image has bleeding the image as a harmful image, policy B is a policy that determines if an image has a weapon the image as a harmful image, and policy C is a policy that determines if there is one or more of a drug and a rude behavior in the image the image as harmful, the first image 111 is a harmful image according to policy A and policy B because the first image 111 shows a weapon and bleeding but no rude behavior or drugs, but according to policy C, the first image 111 is not a harmful image. However, even though there are no weapons, bleeding and drugs, since there is a rude behavior, according to policy A and policy B, the second image 112 is not a harmful image but according to policy C, the second image 112 is a harmful image.

However, a specific method for determining a final class based on the prediction score may be problematic. For example, in certain embodiments, after obtaining a category for each subtask based on the prediction scores, a final class may be determined based on the category for each subtask, but determining how high the prediction score must be to change the category related to the subtask (for example, determining how high the prediction score must be to determine that the image has a weapon in relation to the weapon subtask) may be an important factor in securing classification accuracy. Specifically, if users are exposed to harmful content due to problems such as incompleteness of the model or incorrect setting of threshold values related to the prediction scores, in addition to harming people's mental health, problems such as placing a significant burden on online services under strict government regulation may be caused.

Further, setting an optimal threshold value for various subtasks is not simple. Specifically, since the prediction scores of a machine learning model are often not moderated, it may be difficult to determine the optimal threshold value for each subtask. For example, a threshold value 0.42 may be a sufficiently high threshold value for a first subtask but may be not so for a second subtask, and when there are multiple subtasks, classification accuracy and performance deteriorate when the same threshold value is used for the multiple subtasks, and thus effective and reliable automated determinations may not be made.

With regard thereto, processes in accordance with a variety of embodiments of the invention search for an optimal threshold value of each subtask to obtain a reliable final class for data in a cost-effective manner.

Hereinafter, for convenience of explanation, the subject performing the method according to example embodiments will be unified and described as an “electronic apparatus.” However, the subject performing the method of the example embodiments is not limited to the electronic apparatus. In several embodiments of the invention, at least some of the methods described as performed by the electronic apparatus may be performed by other entities such as humans or mechanical apparatuses.

In many embodiments, an electronic apparatus, which is a subject performing a method according to the example embodiments, may include a plurality of computer systems or computer software implemented as a network server. In numerous embodiments, the electronic apparatus may refer to a computer system and computer software that are connected to a sub-apparatus that communicates with other network servers through a computer network, including but not limited to networks such as an intranet or the Internet, and receive requests for performing tasks and performing actions on the requests and providing the results of the actions. In certain embodiments, the electronic apparatus may be understood as a broad concept including a series of application programs that can operate on a network server and various databases built therein. In some embodiments, the electronic apparatus may be implemented using network server programs provided in various ways according to an operating system such as (but not limited to) DOS, Windows, Linux, UNIX and MacOS.

In additional embodiments, operations related to a method for setting criteria for classifying a series of data according to various example embodiments may be implemented by a single physical apparatus and may be implemented in a manner in which a plurality of physical apparatuses are combined. In many embodiments, some of the plurality of operations included in the method for setting criteria for classifying data on example embodiments may be implemented by one physical apparatus and some of the operations may be implemented in other physical apparatuses. In many embodiments, any one physical apparatus may be implemented as part of an electronic apparatus, and the other physical apparatuses may be implemented as part of other external apparatuses. In some embodiments, each element included in the electronic apparatus may be distributed and disposed in different physical apparatuses, and the distributed elements may be organically combined to perform functions and operations of the electronic apparatus. In several embodiments, the electronic apparatus of the present disclosure includes at least one sub-apparatus, and some operations described as being performed by the electronic apparatus may be performed by a first sub-apparatus, and some other operations may be performed by a second sub-apparatus.

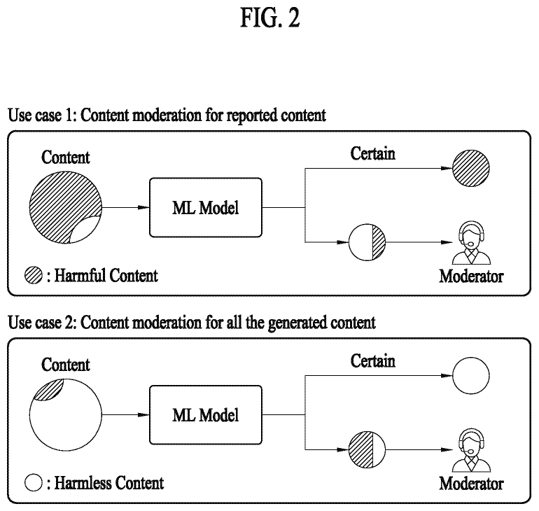

A method of determining how well data classification is performed, together with examples related to data classification in accordance with an embodiment of the invention is illustrated in FIG. 2. FIG. 2 illustrates Use case 1 and Use case 2 in accordance with several embodiments of the invention. Use case 1 corresponds to an example embodiment in which reported content is reviewed to determine whether the reported content corresponds to harmful content. Use case 2 corresponds to an example embodiment in which all contents are reviewed to determine whether all of the contents correspond to harmful contents. In Use case 1, the content reported by a user is targeted, and thus whether the content is harmful may be determined under the assumption that, with regard to the data to be determined, the amount of data that is harmful content is greater than the amount of data that is harmless. In this case, the electronic apparatus may determine obviously harmful content using a machine learning model, and an administrator may manually review contents other than the obviously harmful content.

With regard thereto and Use case 1, in some embodiments, determining whether to manually review may be as shown in Equation 1 below.

$${f}_{p} ( x ) = \{ \begin{matrix}1 , & if {m}_{p} ( x ) > {τ}_{p} , \\ 0 , & otherwise ,\end{matrix} \qquad ( 1 )$$

mₚ(x) is a prediction probability value that machine learning model my predicts and outputs whether content x is harmful. tₚ is a threshold value for determining whether to manually review the content. ƒₚ(x) may be a value indicating whether to manually review the content as a result.

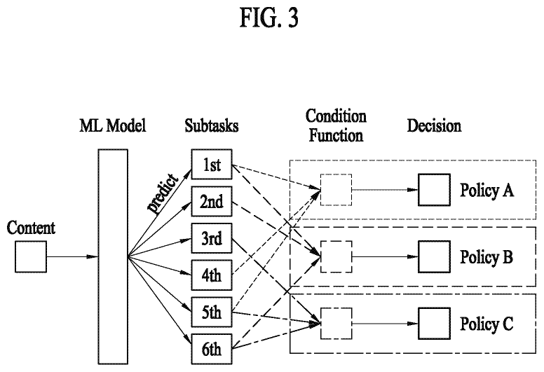

In several embodiments, ty may be determined based on policy p. Meanwhile, with regard to Use case 1 and Use case 2 of the present disclosure, in many embodiments, the machine learning model is dependent on policy p. In certain embodiments, machine learning models may be designed and trained independent of a policy, and detailed descriptions regarding examples of such models will be described later in FIGS. 3 to 5.

In some embodiments, in Use case 1, if a value of ƒₚ(x) is 1, manual review is omitted as the content is considered obviously harmful content, but if the value of ƒₚ(x) is 0, manual review may be proceeded.

However, with regard to Use case 2, in many embodiments, determining whether to manually review content may be as shown in Equation 2 below.

$${f}_{p} ( x ) = \{ \begin{matrix}1 , & if {m}_{p} ( x ) > {τ}_{p}^{′} , \\ 0 , & otherwise ,\end{matrix} \qquad ( 2 )$$

Unlike Equation 1, mₚ (x) corresponds to a predicted probability value that machine learning model my predicts and outputs whether content x is “harmless.” Meanwhile, t′ₚ is a threshold value for determining whether to manually review the content, and ƒₚ(x) may be a value indicating whether to manually review the content as a result. t′ₚ may be determined based on various policies.

In several embodiments, in Use case 2, if a value of ƒₚ(x) is 1, manual review may be omitted as the content is considered as apparently harmless content, but if a value of ƒₚ (x) is 0, manual review may be proceeded.

In several embodiments, depending on which category the majority of content belongs to, a method of manually determining data to be reviewed may also be different.

In certain embodiments, determining the performance of data classification in the present disclosure may be based on one or more of precision, recall, and/or accuracy. With regard thereto, precision is an index that indicates the ratio of data with true class among data classified as “True.” Recall is an indicator that indicates the ratio of data classified as “True” among data whose actual class is “True.” Accuracy is an indicator indicating the ratio of data classified in accordance with the actual class among the total data.

In certain embodiments, regarding the operation of determining precision, recall, and/or accuracy, which class to set as “True” may be determined in various ways based on various circumstances such as the purpose to be achieved through classification. In many embodiments, with regard to Use case 1 and Use case 2, a harmful content may be viewed as “True” in Use case 1 whereas harmless content may be viewed as “True” in Use case 2, and vice versa.

In several embodiments, as an example of optimizing the performance of data classification, a loss function that reflects one or more of precision and recall related to the classification of data may be obtained, and a threshold value may be determined in a direction in which a value of the loss function is minimized. In many embodiments, the process of determining the threshold value may include an example embodiment in which one or more parameters, including the threshold value, are learned in a direction in which the value of the loss function is minimized.

In several embodiments, the loss function is shown in Equation 3 below.

$$ℒ = - recall + α max ( {precision}_{t} - precision , 0 ) \qquad ( 3 )$$

[symbol]

is the loss function. recall is a recall value according to a classification result. precisionₜ is a target precision value. precision is a precision value according to the classification result.

In Equation 3, if a >>1, and if the target precision is not achieved, a large penalty is given to the loss function value in proportion to the degree of falling short of the target precision (in other words, the loss function value increases significantly), but after achieving the target precision, further precision improvement does not affect the loss function, and the loss function may decrease in proportion to the recall. In additional embodiments, the threshold value may be determined with the goal of maximizing recall while achieving a target precision.

For reference, in the present disclosure, optimization of threshold values in order to improve data classification performance is mainly described, but improving model performance may also be an effective way to improve the performance of data classification.

A method of classifying data based on one or more subtasks in accordance with an embodiment of the invention is illustrated in FIG. 3. Referring to FIG. 3, in some embodiments, the electronic apparatus may identify one or more subtasks related to the classification of target data and may classify the target data based on one or more identified subtasks. With regard thereto, in some embodiments, the subtasks related to the classification of target data may be determined based on rule information (for example, policy) related to classification.

More specifically, with regard to the example embodiment illustrated in FIG. 3, if target data is classified based on policy A, the electronic apparatus may determine the target data class based on a first subtask, a fourth subtask and a fifth subtask. Further, if the target data is classified based on policy B, the electronic apparatus may determine the target data class based on the first subtask, a second subtask and a sixth subtask. In addition, if the target data is classified based on policy C, the electronic apparatus may determine the target data class based on a third subtask, the fifth subtask and the sixth subtask.

In many embodiments, a condition function reflecting the contents of each rule information may be obtained, and the condition function may include at least one of information regarding which subtasks to consider for data classification and information about how to consider each subtask (e.g., thresholds for each subtask).

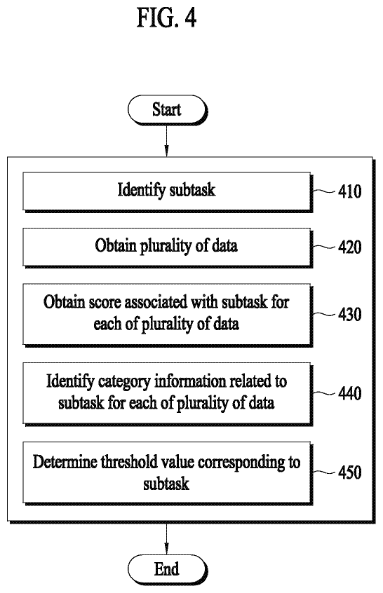

In certain embodiments, an electronic apparatus may classify target data based on a threshold value determined based on an operation of FIG. 4 to be described later. More specifically, in many embodiments, the electronic apparatus may input target data to the machine learning model, obtain an output of the machine learning model, obtain category information corresponding to the target data by comparing the obtained output with a threshold value, and finally determine the class of the target data based on the obtained category information.

In additional embodiments, the electronic apparatus may identify rule information associated with data classification of the model and one or more subtasks related to the rule information, and obtain information of one or more set threshold values corresponding to one or more subtasks. With regard thereto, in a number of embodiments, the electronic apparatus may use the trained model and, after the model used by the electronic apparatus is first determined, rule information of and one or more subtasks may be identified based on the determined result. Conversely, after rule information and one or more subtasks are first identified, which model to use may be determined based on the identified result. The specific methods do not limit the scope of the present disclosure.

In other embodiments, an operation of obtaining information on one or more set threshold values may include an operation of obtaining information on a threshold value determined by processes described throughout the present disclosure. However, the operation is not limited thereto.

In several embodiments, the electronic apparatus may obtain subject data and may output a result of compliance with rule information for subject data based on information of one or more threshold values. With regard thereto, “subject data” may be related to “target data” described throughout the present disclosure, and this may be understood as dividing the expression in order to more clearly explain the operation in the inference step, but it is not limited thereto.

Further, it is described that the subject data is obtained after operations such as model determination, rule information verification, and one or more subtasks verification, and threshold value information obtainment are performed, but it is only for convenience of description. It may be understood that the present disclosure includes various example embodiments in which the order that each action is performed is changed. For example, it may be understood that the present disclosure includes an example embodiment that after the subject data is obtained first, (for example, based on the attributes of the subject data) a model is determined, rule information is identified and at least one subtask is identified.

In many embodiments, the electronic apparatus may include outputting a result of whether the rule information for subject data is complied with based on information of one or more threshold values. In additional embodiments, the electronic apparatus may output score information corresponding to the subject data based on one or more subtasks, and the electronic apparatus may compare score information and information on one or more threshold values to output a result of compliance with the rule information.

In some embodiments, the electronic apparatus may output a result of compliance with the rule information using a plurality of sub-models. For example, the electronic apparatus according to an example embodiment may perform an operation of outputting score information corresponding to the subject data using the second sub-model, the score information may be transferred from a second sub-model to a first sub-model, and the electronic apparatus may perform an operation of comparing score information and one or more threshold value information using the first sub-model and output a result of compliance with the rule information.

In many embodiments, more specifically in relation to the operation of outputting a result of compliance with the rule information by comparing score information and information of one or more threshold values, the electronic apparatus may obtain category information of the subject data related to one or more subtasks based on a result of comparing the score information and information on one or more threshold values, and may determine whether the rule information is complied with based on the category information. In several embodiments, the electronic apparatus may obtain the category “YES” for the subtask “Weapons” if the score information is 90 points and the threshold value is 88 points, and based thereon, the electronic apparatus may determine that the rule information is not complied with (in other words, it may be determined as “Harmful”).

Returning back to the description related to the classification of the target data, in many embodiments, if a set of one or more subtasks related to the classification of data is defined as S={S₁, S₂, . . . , Sₙ}, a more specific example of obtaining category information corresponding to the target data in relation to i-th subtask may be as shown in Equation 4 below.

$${s}_{i} ( x ) = \{ \begin{matrix}1 , & if {m}_{{s}_{i}} ( x ) > {τ}_{{s}_{i}} \\ 0 , & otherwise\end{matrix} , \qquad ( 4 )$$

mₛᵢ is the machine learning model associated with the i-th subtask. mₛᵢ(x) is the output obtained by inputting data x to the machine learning model associated with the i-th subtask. Tₛᵢ is the threshold value corresponding to the i-th subtask. sᵢ(x) is category information corresponding to the target data obtained in relation to the i-th subtask.

With regard thereto, for convenience of explanation, a case in which category information indicates a first category by having a value of 0 and indicates a second category by having a value of 1 is described throughout the present disclosure. However, in several embodiments, in addition to having a value of 0 or 1, various values may be used to indicate the category, the category information does not necessarily indicate either one of the two categories (in other words, category information may indicate one of three or more categories), and all of the various example embodiments may fall within the scope of the present disclosure.

In many embodiments, the electronic apparatus may obtain rule information related to classification of target data and determine a class of the target data based on the rule information and category information. In certain embodiments, the electronic apparatus may obtain set of category as a information such Oₛ(x)={s₁(x), s₂(x), . . . , Sₙ(x)} by obtaining category information for each subtask, and the electronic apparatus may determine a class of the target data based on the rule information (for example, the rule information may include specific content of a policy) and the set of obtained category information.

In still many embodiments, regarding Oₛₚ (x)={s₁^{p}(x), s₂^{p}(x), . . . }, which is category information for each subtask related to policy p, an example of function ƒₚ (x) for determining the class of the target data may be as shown in Equation 5 below.

$${f}_{p} ( x ) = {d}_{p} ( {O}_{{S}_{p}} ( x ) ) = {d}_{p} ( {\{ ( {m}_{{s}^{p}} ( x ) > {τ}_{{S}^{p}} ) \}}_{{s}^{p} ∈ {S}_{p}} ) \qquad ( 5 )$$

dₚ(·) may be a decision function that takes a subtask category as an input and outputs a class. With regard thereto, a value of dₚ(·) may be determined as 0 or 1, and the values of 0 and 1 may indicate different classes. However, the scope of the present disclosure is not limited thereto.

In several embodiments, dₚ(·) may be defined as Boolean operations. For example, in a case of an image with a child, even if only one of weapon and a violent action exists, the image may be determined as harmful content. An example of the decision function dₚ(·) in this regard may be as shown in Equation 6 below.

$${d}_{p} ( {O}_{{S}_{p}} ( x ) ) = ( {s}_{kids} ( x ) AND ( {s}_{weapon} ( x ) OR {s}_{violence} ( x ) ) \qquad ( 6 )$$

Meanwhile, the example shown in FIG. 3 corresponds to an example of obtaining prediction scores for all subtasks based on one machine learning model, but the scope of the present disclosure is not limited thereto, and for different subtasks, different machine learning models may be used to obtain prediction scores. Also, the scope of the present disclosure is not limited to that different machine learning models are used for different subtasks, and the same model or different models may be used for each subtask. And thus, it should be understood that various example embodiments exist with respect to which model is used.

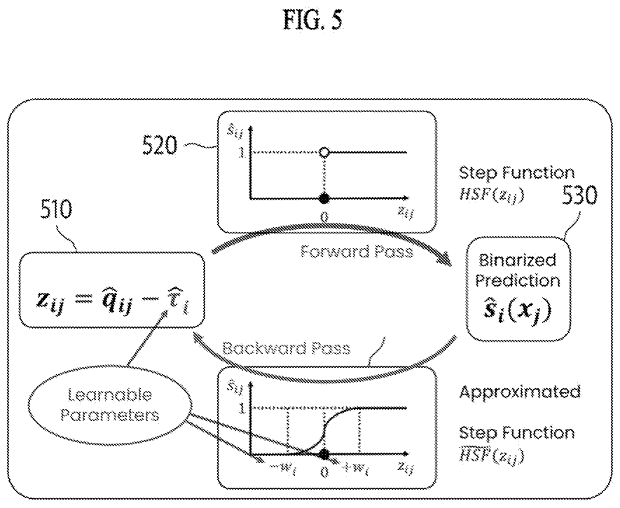

For descriptions related to FIGS. 4 and 5 below, symbols may be defined and used as follows.
p: a target policy
Sₚ={s₁^{p}, s₂^{p}, . . . }: a set of one or more subtasks
Tₚ={t₁^{p}, t₂^{p}, . . . } a set of threshold values corresponding to each subtask
[symbol] ₚ: a set of data collected related to policy p
[symbol] ={q₀ⱼ, q₁ⱼ, . . . }: a set of prediction scores corresponding to j-th data sample included in [symbol] ₚ.

With regard thereto, qui may be a symbol expressed by simplifying mₛ_{ᵢ}^{p} (x) for convenience. In other words, qᵢⱼ may be an output obtained by inputting xⱼ, the j-th data sample included in [symbol] ₚ, to a machine learning model associated with the i-th subtask.

For example, according to the symbols, an example of a more generalized and conceptualized example of Equation 3 which aims to maximize recall while achieving target precision, may be expressed as Equation 7 below.

$${maximize}_{{T}_{p}} recall ( {T}_{p} \vert {𝒟}_{p} , {d}_{p} ) \qquad ( 7 )$$

$$subject to precision ( {T}_{p} \vert {𝒟}_{p} , {d}_{p} ) \geq {precision}_{t}$$

FIG. 4 is an operation flowchart illustrating a method of setting a criterion for classifying data according to an example embodiment.

Referring to FIG. 4, in operation 410, an electronic apparatus according to an example embodiment identifies subtasks related to data classification. The detailed description and the example embodiments related to identifying the subtasks are described above with reference to FIG. 3. According to an example embodiment, the set of one or more identified subtasks may correspond to Sₚ={s₁^{p}, s₂^{p}, . . . }.

In operation 420, the electronic apparatus obtains a plurality of data. In many embodiments, a plurality of data may correspond to a data set [symbol] ₚ collected in relation to policy p.

In operation 430, the electronic apparatus obtains scores associated with the subtasks for each of the plurality of data based on a model associated with the subtasks. In several embodiments, the scores obtained in association with the subtasks may correspond to the above-described prediction scores.

More specifically, in many embodiments still, an electronic apparatus according may input a plurality of data to the model associated with the subtasks, and obtain the output of the model for each of the plurality of data. For example, the electronic apparatus may obtain output qᵢⱼ by inputting the j-th data xⱼ to machine learning model mₛᵢ related to subtask sᵢ.

Meanwhile, as described above, different machine learning models are not necessarily associated with different subtasks. At least some of the subtasks may be related to the same machine learning model.

In many embodiments, the electronic apparatus may normalize an output obtained for each of the plurality of data, and the normalized result may correspond to the scores obtained in operation 430. In some embodiments, the electronic apparatus may normalize the output per subtask, the scores obtained as the normalized result may have a value between 0 and 1, and an example of the result of performing normalization in this way may be as shown in Equation 8 below.

$${\hat{q}}_{ij} = \frac{rank ( {q}_{ij} , \{ {q}_{i 1} , {q}_{i 2} , … , {q}_{i \vert {𝒟}_{p} \vert} \} )}{\vert {𝒟}_{p} \vert} \qquad ( 8 )$$

\hat{q}ᵢⱼ may be the result of normalizing output qᵢⱼ, and rank (x,X) may be a rank of data x of the set X. [symbol] ₚ| may be the number of data samples belonging to [symbol] ₚ. With regard thereto, the rank may be sorted in ascending order, but the scope of the present disclosure is not limited thereto.

In the example of Equation 8 above, \hat{q}ᵢⱼ may be normalized to a value between 0 and 1 by reflecting the rank in the set of outputs belonging to subtask sᵢ. Since each subtask may have a different data distribution, if the output obtained for each data is used as it is, the prediction score distribution may be skewed, and as a result, threshold value optimization may be difficult. However, in case of going through the normalization process for each subtask, the skew of the prediction score distribution may be removed and thus distribution-agnostic threshold value optimization for prediction scores may be performed.

Hereinafter, for convenience of explanation, an example embodiment in which a score is obtained by normalizing an output to have a value between 0 and 1 will be described. However, the example embodiment is a mere example. The electronic apparatus does not necessarily normalize the output to obtain a score. There may be various example embodiments such as that even when a score is obtained by normalizing the output, the normalized result has a value in a different range than between 0 and 1 and that an output per subtask is not normalized. Even in the cases, the following description may be applied.

For example, hereinafter, it will be indicated that it is a normalized value by collectively displaying a hat ( [symbol] ) for symbols, but if an obtained score is not a normalized value, it may be understood by interpreting the following symbols as having no hat ( [symbol] ).

In operation 440, the electronic apparatus identifies category information related to a subtask for each of the plurality of data. With regard thereto, the operation of obtaining categories for each subtask based on the prediction scores is described in relation to FIG. 1, but the operation corresponds to the process of determining the class of target data based on the determined threshold value. Operation 410 to operation 450 correspond to operations for determining a threshold value (so that the class of the target data can be determined based on the threshold value later), and thus it should be noted that the operation of obtaining categories in FIG. 1 does not correspond to the operations. In other words, it should be noted that the operation of identifying category information in operation 440 includes a case of loading pre-labeled category information or a case of obtaining category information through human labeling, and the category is not obtained based on the scores obtained in operation 430.

In operation 450, the electronic apparatus determines threshold values corresponding to the subtasks based on the category information and the scores. The electronic apparatus according to an example embodiment may set a threshold function that takes as an input a value obtained by subtracting a threshold value corresponding to a subtask from a score obtained to be associated with a subtask, and learn the optimal form of the threshold function based on the category information and the score. With regard thereto, the threshold function may be learned to output a value related to the category information.

More specifically, in many embodiments, the electronic apparatus may obtain a differentiable similar threshold function based on the threshold function, and may update one or more parameters including a threshold value by performing a backward pass or back-propagation on the obtained similar threshold function. As such, learning may be performed in the process of updating parameters. With regard thereto, one or more parameters according to an example embodiment may further include a parameter related to a form of a similar threshold function in addition to the threshold value.

If parameters related to the form of the similar threshold function are further learned, in conclusion, the learned threshold value may have a value closer to the optimal value.

A more detailed example embodiment related to determining a threshold value corresponding to a subtask is shown in FIG. 5. Referring further to FIG. 5, the electronic apparatus in several embodiments may obtain value zᵢⱼ that is obtained by subtracting the threshold value \hat{t}ᵢ^{p} corresponding to the subtask from score \hat{q}ᵢⱼ obtained to be associated with the subtask as indicated in reference numeral 510, and use the value as an input to the threshold function. With regard thereto, \hat{t}ᵢ^{p} may correspond to a normalized threshold value, which allows a value of xⱼ to be determined by whether a value of \hat{q}ᵢⱼ is greater than \hat{t}ᵢ^{p}. In other words, \hat{t}ᵢ^{p} may correspond to a threshold value of normalized subtask ŝᵢ^{p}.

In several embodiments, the electronic apparatus may obtain tᵢ^{p} from \hat{t}ᵢ^{p} based on known techniques such as linear interpolation, and thus it may be understood that obtaining \hat{t}ᵢ^{p} is substantially the same as the obtaining tᵢ^{p}.

Meanwhile, there may be a question about how to take a value that a threshold value as an input before obtaining the threshold value yet, but since operation 450 is an operation of optimizing the threshold value, it may be understood that the threshold value is gradually learned to have a value close to the optimum as the operation 450 is performed, and what value the initial value is set to does not limit the scope of the present disclosure.

As in an example embodiment of FIG. 5, if value zᵢⱼ obtained by subtracting threshold value \hat{t}ᵢ^{p} corresponding to the subtask from score \hat{q}ᵢⱼ obtained to be associated with the subtask is used as an input of the threshold function, this may correspond to an input scaled such that its output value is varied based on 0, for example. Therefore, a graph that takes zᵢⱼ as an input and outputs category information (or a normalized value of the category information) of the j-th data sample may have the form of a Heaviside Step Function (HSF) as indicated in reference numeral 520. (For convenience of description, the category information having a value of 0 or 1 is described above in related to Equation 4.)

In certain embodiments, in order to update one or more parameters including a threshold value, methods in which learning is performed through backpropagation, such as Surrogate Gradient Learning (SGL), may be used, but since the step function is not differentiable, there may be a problem that backpropagation may not be performed properly. With regard thereto, in many embodiments, the problem may be solved, as described above, by obtaining a differentiable similar threshold function based on the threshold function and performing backpropagation on the obtained similar threshold function. In many embodiments, a similar threshold function may be obtained so that it becomes a sigmoid function that retains the properties of the threshold function (or has similar properties).

A similar threshold function according to an example may be as shown in Equation 9 below.

$$( {𝓏}_{ij} ) = \{ \begin{matrix}0 , & if {𝓏}_{ij} < - {w}_{i} , \\ \frac{1}{2} sin ( \frac{{π𝓏}_{ij}}{2 {w}_{i}} ) + \frac{1}{2} , & if - {w}_{i} \leq {𝓏}_{ij} \leq {w}_{i} , \\ 1 , & otherwise ,\end{matrix} . \qquad ( 9 )$$

A form of the similar threshold function is shown in reference numeral 540. With regard thereto, wᵢ, a parameter related to the form of the similar threshold function, may be learned while being updated through backpropagation. Parameter wᵢ may be expressed as sigmoid(ωᵢ), and may be understood as a parameter related to how much a data sample is truncated.

More specifically in relation to the parameter update process, in a forward pass or forward propagation process, a binarized predicted value ŝᵢ(xⱼ) may be obtained as indicated in reference numeral 530, and furthermore, by performing this for each data and each subtask, a final binarized prediction result may be obtained, for example, as shown in Equation 10 below.

$$\begin{matrix}{\tilde{y}}^{p} = {\tilde{d}}_{p} ( \{ {\hat{s}}_{0}^{p} ( x ) , {\hat{s}}_{1}^{p} ( x ) , … \} ) \\ = {\tilde{d}}_{p} ( \{ HSF ( {\hat{q}}_{0} - {\hat{τ}}_{0}^{p} ) , HSF ( {\hat{q}}_{1} - {\hat{τ}}_{1}^{p} ) , … \} )\end{matrix} . \qquad ( 10 )$$

\tilde{d}ₚ may correspond to a function designed as a numerical version of the decision function dₚ (·).

As a result, classification performance may be determined by comparing prediction \tilde{Y}P={y₀^{p}, y₁^{p}, . . . } for each data with category YP={y₀^{p}, y₁^{p}, . . . }, and this may include, for example, an operation of obtaining the above-described loss function.

Further, in the backpropagation process, surrogate gradient for zᵢⱼ may be calculated, and a related example may be as shown in Equation 11 below.

$${Θ}^{′} ( {𝓏}_{ij} ) = \{ \begin{matrix}0 , & if \vert {𝓏}_{ij} \vert > {w}_{i} , \\ \frac{\partial }{\partial {𝓏}_{ij}} ( \frac{1}{2} sin ( \frac{{π𝓏}_{ij}}{2 {w}_{i}} ) + \frac{1}{2} ) = \frac{π}{4 {w}_{i}} cos ( \frac{{π𝓏}_{ij}}{2 {w}_{i}} ) , & otherwise ,\end{matrix} \qquad ( 11 )$$

Equation 11 may be understood as a surrogate gradient when using the similar threshold function according to the example of Equation 9.

In several embodiments, the electronic apparatus may update threshold value tᵢ^{p} by calculating the gradient of the loss function for the threshold value using the surrogate gradient. An example may be as shown in Equation 12 below.

$$\begin{matrix}\frac{\partial ℒ}{\partial {τ}_{i}^{p}} = {\sum }_{j} \frac{\partial ℒ}{\partial {\tilde{y}}_{j}^{p}} \frac{\partial {\tilde{y}}_{j}^{p}}{\partial {τ}_{i}^{p}} = {\sum }_{j} \frac{\partial ℒ}{\partial {\tilde{y}}_{j}^{p}} \frac{\partial {\tilde{y}}_{j}^{p}}{\partial H SF ( {𝓏}_{ij} )} \frac{\partial H SF ( {𝓏}_{ij} )}{\partial {τ}_{i}^{p}} \\ = {\sum }_{j} \frac{\partial ℒ}{\partial {\tilde{y}}_{j}^{p}} \frac{\partial {\tilde{y}}_{i}^{p}}{\partial HSF ( {z}_{ij} )} \frac{\partial HSF ( {𝓏}_{ij} )}{\partial {𝓏}_{ij}} \frac{\partial {𝓏}_{ij}}{\partial {τ}_{i}^{p}} \\ \approx {\sum }_{j} - \frac{\partial ℒ}{\partial {\tilde{y}}_{j}^{p}} \frac{\partial {\tilde{y}}_{j}^{p}}{\partial HSF ( {𝓏}_{ij} )} {Θ}^{′} ( {𝓏}_{ij} )\end{matrix} . \qquad ( 12 )$$

In additional embodiments, wᵢ may be updated by calculating surrogate gradient Θ′(wᵢ) as an input as shown in Equation 13 below and by calculating the gradient of the loss function for wᵢ using the surrogate gradient as Equation 14.

$${Θ}^{′} ( {w}_{i} ) = \{ \begin{matrix}0 , & if \vert {𝓏}_{ij} \vert > {w}_{i} , \\ \frac{\partial }{\partial {w}_{i}} ( \frac{1}{2} sin ( \frac{{π𝓏}_{ij}}{2 {w}_{i}} ) + \frac{1}{2} ) = - \frac{{π𝓏}_{ij}}{4 {w}_{i}^{2}} cos ( \frac{{π𝓏}_{ij}}{2 {w}_{i}} ) , & otherwise ,\end{matrix} \qquad ( 13 )$$

$$\frac{\partial ℒ}{\partial {w}_{i}} \approx {\sum }_{j} \frac{\partial ℒ}{\partial {\tilde{y}}_{j}^{p}} \frac{\partial {\tilde{y}}_{j}^{p}}{\partial HSF ( {𝓏}_{ij} )} {Θ}^{′} ( {w}_{i} ) \qquad ( 14 )$$

As a result, through this process, the threshold value is learned in the direction that the loss function targets, thereby optimizing the performance of data classification.

The above description of FIG. 5 should be understood as an example embodiment for clearly understanding the content of the present disclosure, and should not be understood as limiting the scope of the present disclosure thereto. For example, the scope of the present disclosure is not limited to the case where the threshold function is the HSF. The scope of the present disclosure is not limited to the case where the similar threshold function uses a sine function as shown in Equation 9. The scope of the present disclosure is not limited to learning a parameter including a threshold value according to the SGL model. For example, the threshold function may take a score itself obtained to be related to a subtask as an input. In this case, the threshold function may be a function obtained by parallel shifting the HSF in the x-axis direction. In another example, without distinguishing between a threshold function and a similar threshold function, both the forward pass or forward propagation process and the back-propagation process may be performed with one function by using a differentiable function even during the forward pass or forward propagation. In addition, it may be understood that various example embodiments not separately described are included in the scope of the present disclosure.

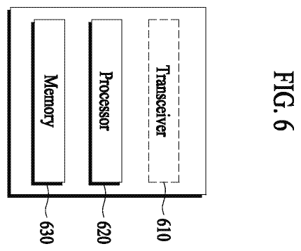

FIG. 6 is a diagram of the configuration of an electronic apparatus for setting criteria for classifying data in accordance with an embodiment of the invention.

Referring to FIG. 6, the electronic apparatus includes a processor 620 and a memory 630, and may further include a transceiver 610. The electronic apparatus may be connected to other external apparatuses through the transceiver 610 and exchange data.

The processor 620 may include at least one of the apparatuses described above with reference to FIGS. 1 to 5 or may perform at least one of the methods described above with reference to FIGS. 1 to 5. The memory 630 may store information for performing at least one of the methods described above through FIGS. 1 to 5. The memory 630 may be volatile memory or non-volatile memory.

The processor 620 may execute a program and control an electronic apparatus for providing information. Program codes executed by the processor 620 may be stored in the memory 630.

In many embodiments, the electronic apparatus may include a UI that provides information to a user, and based thereon, an input may be received from the user.

Meanwhile, in the present disclosure and drawings, example embodiments are disclosed, and certain terms are used. However, the terms are only used in general sense to easily describe the technical content of the present disclosure and to help the understanding of the present disclosure, but not to limit the scope of the present disclosure. It is apparent to those of ordinary skill in the art to which the present disclosure pertains that other modifications based on the technical spirit of the present disclosure may be implemented in addition to the example embodiments disclosed herein.

In several embodiments, the electronic device according to the above-described example embodiments may include a processor, a memory for storing and executing program data, a permanent storage such as a disk drive, and/or a user interface device such as a communication port, a touch panel, a key and/or a button that communicates with an external device. Methods implemented as software modules or algorithms may be stored in a computer-readable recording medium as computer-readable codes or program instructions executable on the processor. In many embodiments, the computer-readable recording medium includes a magnetic storage medium (for example, ROMs, RAMs, floppy disks and hard disks) and an optically readable medium (for example, CD-ROMs and DVDs). In some embodiments, the computer-readable recording medium may be distributed among network-connected computer systems, so that the computer-readable codes may be stored and executed in a distributed manner. The medium may be readable by a computer, stored in a memory, and executed on a processer.

The example embodiments may be represented by functional block elements and various processing steps. The functional blocks may be implemented in any number of hardware and/or software configurations that perform specific functions. For example, an example embodiment may adopt integrated circuit configurations, such as memory, processing, logic and/or look-up table, that may execute various functions by the control of one or more microprocessors or other control devices. Similar to that elements may be implemented as software programming or software elements, the example embodiments may be implemented in a programming or scripting language such as C, C++, Java, assembler, Python, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing. Terms such as “mechanism,” “element,” “means” and “configuration” may be used broadly and are not limited to mechanical and physical elements. The terms may include the meaning of a series of routines of software in association with a processor or the like.

The above-described example embodiments are merely examples, and other embodiments may be implemented within the scope of the claims to be described later.

What is claimed is:

1. A method of setting criteria for classification of data in an electronic apparatus, the method comprising:
identifying a plurality of subtasks related to a data classification;
obtaining a plurality of data;
based on a model associated with the plurality of subtasks, obtaining a score associated with each subtask for each of the plurality of data;
identifying category information associated with each subtask for each of the plurality of data; and
based on the category information and the scores for the plurality of data, determining a threshold value for each of the plurality of subtasks; and
utilizing the threshold values for the plurality of subtasks for the data classification.

2. The method of claim 1, wherein determining the threshold value includes:
setting a threshold function that takes a value obtained by subtracting the threshold value from the score as an input; and
learning an optimal form of the threshold function based on the category information and the score,
wherein the threshold function is learned to output a value associated with the category information.

3. The method of claim 2, wherein the threshold function includes a Heaviside step function (HSF).

4. The method of claim 2, wherein learning an optimal form of the threshold function includes:
obtaining a differentiable similar threshold function based on the threshold function; and
updating one or more parameters of the threshold function including the threshold value by performing backpropagation on the differentiable similar threshold function.

5. The method of claim 4, wherein the differentiable similar threshold function includes a sigmoid function.

6. The method of claim 4, wherein the one or more parameters include a parameter related to a form of the differentiable similar threshold function.

7. The method of claim 1, wherein determining the threshold value includes:
obtaining a loss function that reflects at least one of precision and recall related to the data classification; and
determining the threshold value in a direction in which a value of the loss function is minimized.

8. The method of claim 1, wherein obtaining the score includes:
inputting the plurality of data into the model; and
obtaining an output of the model for each of the plurality of data.

9. The method of claim 8, wherein obtaining the score further includes obtaining the score by normalizing the output of the model to a value between 0 and 1.

10. The method of claim 1, further comprising:
obtaining target data associated with the subtask; and
classifying the target data based on the threshold value.

11. The method of claim 10, wherein classifying the target data includes:
inputting the target data to the model;
obtaining an output of the model; and
obtaining the category information corresponding to the target data by comparing the output of the model with the threshold value.

12. The method of claim 11, wherein classifying the target data further includes:
obtaining rule information related to a classification of the target data; and
determining a class of the target data based on the rule information and the category information corresponding to the target data.

13. A computer-readable non-transitory recording medium having a program for executing the method of claim 1 on a computer.

14. A method of providing information in an electronic apparatus using a trained model, the method comprising:
identifying rule information associated with a data classification of a model and a set of one or more subtasks related to the rule information;
obtaining information on one or more set threshold values corresponding to each of the set of subtasks;
obtaining subject data; and
based on the information on the one or more set threshold values, outputting a result of whether the subject data complies with the rule information.

15. The method of claim 14, wherein outputting the result of whether the subject data complies with the rule information includes:
outputting score information corresponding to the subject data based on at least one subtask; and
retrieving a comparison of the score information and the information on the one or more set threshold values.

16. The method of claim 15, wherein:
the model includes a first sub-model and a second sub-model;
score information corresponding to the subject data using the second sub-model is outputted;
the score information is transferred from the second sub-model to the first sub-model; and
the score information and the information on the one or more set threshold values are compared by using the first sub-model.

17. The method of claim 15, wherein outputting the result of whether the rule information for the subject data is complied with further includes:
obtaining category information of the subject data associated with the at least one subtask based on a result of the comparison; and
determining whether the rule information is complied with based on the category information.

18. An electronic apparatus of setting criteria for classifying data, comprising:
a memory configured to store instructions; and
a processor,
wherein the processor, connected to the memory, is configured to:
identify a subtask related to data classification;
obtain a plurality of data;
based on a model associated with the subtask, obtain a score associated with the subtask for each of the plurality of data;
identify category information associated with the subtask for each of the plurality of data; and
based on the category information and the score, determine a threshold value corresponding to the subtask.

19. The electronic apparatus of claim 18, wherein the processor, in order to determine the threshold value, is configured to:
set a threshold function that takes a value obtained by subtracting the threshold value from the score as an input; and
learn an optimal form of the threshold function based on the category information and the score,
wherein the threshold function is learned to output a value associated with the category information.

20. The electronic apparatus of claim 19, wherein the threshold function includes a Heaviside step function (HSF).
